(19) United States
(12) Patent Application Publication
(10) Pub. No.: US 2026/0037329 A1
(43) Pub. Date: Feb. 5, 2026

(54) FUNCTION EXECUTION USING SELECTED EXECUTION MODES

(71) Applicant: Dell Products L.P., Round Rock, TX (US)

(72) Inventors: Rajiv Popat, Kolkata (IN); Manav Ghosh, Bangalore (IN)

(21) Appl. No.: 18/794,405

(22) Filed: Aug. 5, 2024

(51) Int. Cl. G06F 9/50

(52) U.S. Cl. CPC G06F 9/5055; G06F 2209/5022

(57) ABSTRACT

Techniques are provided for function execution using selected execution modes. One method comprises obtaining information characterizing execution modes, selected by a given user, for software components of an application, wherein the selected execution modes are selected from a number of available execution modes, wherein at least two of the available execution modes are associated with different amounts of compute resources to allocate to an execution of functions associated with one or more software components; obtaining a function, of a given software component of the application, to be executed for the given user; and initiating an execution of the 10 function using the amount of compute resources associated with the selected execution mode of the given user for the given software component. The available execution modes may comprise a performance execution mode, a sustainability execution mode and/or an automatic execution mode.

### BACKGROUND

Application developers have made significant improvements with respect to application performance. For example, multi-threaded frameworks, multi-processor frameworks, frameworks that employ horizontal scaling and/or frameworks that employ advanced processing techniques (e.g., Map-Reduce techniques) have been employed to improve performance. Most application performance efforts aim to execute each instruction requested by a user in the fastest way possible.

### SUMMARY

Illustrative embodiments of the disclosure provide techniques for function execution using selected execution modes. An exemplary method comprises obtaining information characterizing a plurality of execution modes, selected by a given user, for respective ones of a plurality of software components of an application, wherein the plurality of selected execution modes is selected from a plurality of available execution modes, wherein at least two of the plurality of available execution modes are associated with different amounts of compute resources to allocate to an execution of one or more functions associated with one or more software components; obtaining at least one function, of a given software component of the application, to be executed for the given user; and initiating an execution of the at least one function using the amount of compute resources associated with the selected execution mode of the given user for the given software component.

Illustrative embodiments can provide significant advantages relative to conventional techniques for executing functions. For example, problems associated with existing function execution tools are overcome in one or more embodiments by automatically executing functions using an amount of compute resources associated with an execution mode execution of the at least one function using the amount of compute resources associated with the selected execution mode of the given user by a given user.

These and other illustrative embodiments include, without limitation, methods, apparatus, networks, systems and processor-readable storage media.

### BRIEF DESCRIPTION OF THE DRAWINGS

FIG. 1 is a block diagram of an information processing system that executes functions using selected execution modes in an illustrative embodiment;

FIG. 2 illustrates a pod-based container environment within which one or more illustrative embodiments can be implemented;

FIG. 3 illustrates host devices and a storage system within which one or more illustrative embodiments can be implemented;

FIG. 4 illustrates an example of the sustainable application execution controller of FIG. 1 in an illustrative embodiment;

FIG. 5 illustrates an operation of the software component configuration engine, user preference manager, function execution engine and host resource monitor of FIG. 4 in an illustrative embodiment;

FIG. 6 is a sample table illustrating an exemplary mapping of software functions to software components in an illustrative embodiment;

FIG. 7 is a sample table illustrating user performance profile selections for a number of exemplary software components in an illustrative embodiment;

FIG. 8 is a communication diagram illustrating the techniques for function execution using selected execution modes in an illustrative embodiment;

FIG. 9 is a flow diagram illustrating an exemplary implementation of a process for function execution using selected execution modes in an illustrative embodiment; and

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

As the term is illustratively used herein, a container may be considered lightweight, stand-alone, executable software code that includes elements needed to run the software code. A container-based structure has many advantages including, but not limited to, isolating the software code from its surroundings, and helping reduce conflicts between different tenants or users running different software code on the same underlying infrastructure.

As noted above, most application performance efforts aim to execute each instruction requested by a user in the fastest way possible. There is often an underlying assumption that an application should employ the fastest possible execution of software code. For example, application developers may assume that all user flows are important and that users always prefer the fastest possible execution. While such a mindset provides a good user experience, such a mindset may also cause serious issues with respect to sustainability.

One or more aspects of the disclosure recognize that every use case does not require a high priority execution and that performance improvements, such as horizontal scaling, may impair sustainability in multiple ways. When the addition of servers or containers becomes a default solution to solving performance-related issues, there is a tendency to forget that increasing processing nodes to solve problems faster often leads to higher costs, higher carbon emissions and/or a buildup of electronic waste (or e-waste). In order to support horizontal scaling, additional servers are procured which may lead to an over-provisioning problem, particularly in companies that have on-premises cloud systems for security reasons.

The disclosed techniques for sustainable application execution challenge the belief that horizontal scaling and other performance improvements should be employed in all cases. In one or more embodiments, a framework is provided that can speed up the execution of code using multi-threading while also allowing (and, in some cases, encouraging) developers to consider specific use cases where the system performance can be reduced to encourage sustainable outcomes and thereby reduce overall costs and carbon emissions resulting from code execution. For example, for certain use cases and/or program flows, users may not consider performance to be a primary consideration. In such cases, the users should be allowed to override the “fastest possible execution” assumption and control a balance between performance and sustainability.

In some embodiments, a sustainable application execution framework based on a hybrid model is provided that selectively enables a “sustainable mode” for execution of an application, or portions thereof. For example, each user may pick the sustainable mode for specific program flows.

In this manner, end users may selectively decide to reduce performance in order to obtain a more sustainable outcome. Users may elect a higher performance (and employ technologies such as multi-threading, multi-processing and/or horizontal scaling) when they need speed and may elect a sustainable, lower cost execution in cases where they do not require such speed. In some implementations, a user may be incentivized to sacrifice some performance in return for a lower carbon footprint for those use cases, and at such times, when they can afford to do so.

In at least some embodiments, a task orchestrator (sometimes referred to as a mediator or a function execution engine) is provided that allows application developers to intentionally slow down the execution of designated portions of the codebase and consume a reduced number of processing cores, a reduced number of processing threads and/or a reduced amount of processing time for a designated set of use cases. An end user may selectively sacrifice some performance in return for a more sustainable outcome and control over the carbon footprint generated when they use a web application, for example. End users may be provided with granular control over the use cases that will have (i) a baseline performance level (e.g., a maximum performance with a shorter execution time) using paradigms such as multi-threading, multi-processing and/or horizontal scaling to get the fastest possible outcomes and (ii) a reduced performance (e.g., a longer execution time) to create a more sustainable outcome.

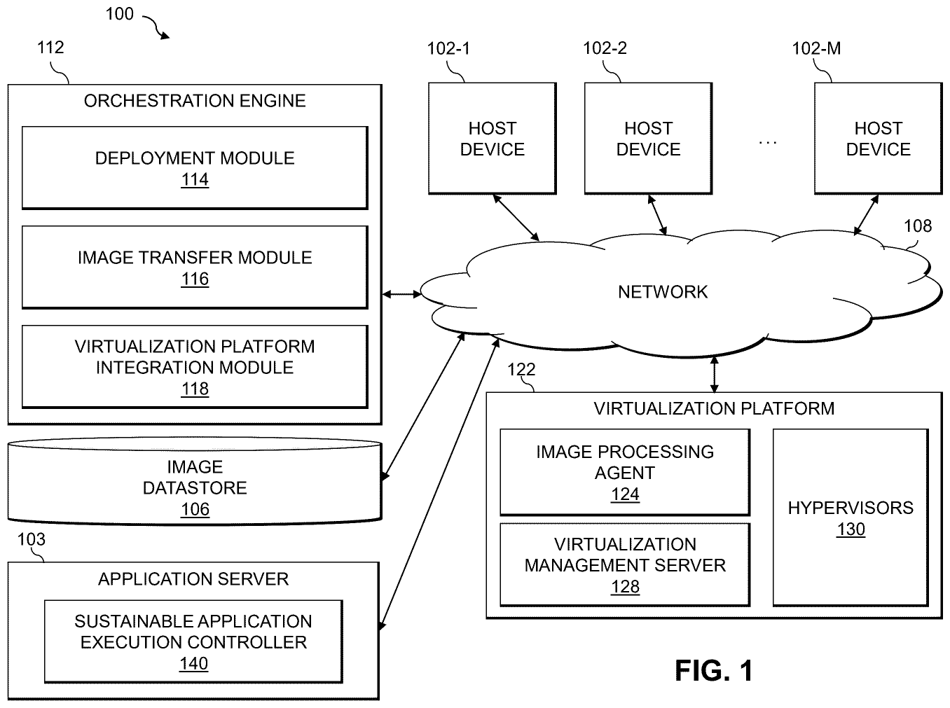

FIG. 1 shows an information processing system 100 configured in accordance with an illustrative embodiment to provide function execution using selected execution modes. The information processing system 100 comprises one or more host devices 102-1, 102-2, . . . 102-M (collectively, host devices 102), one or more application servers 103 (collectively, application servers 103) and an orchestration engine 112 that communicates over a network 108 with one or more virtualization platforms 122. The orchestration engine 112 may deploy one or more containerized applications to one or more of the host devices 102 and/or the virtualization platform 122.

The host devices 102, orchestration engine 112 and/or virtualization platform 122 illustratively comprise respective computers, servers or other types of processing devices capable of communicating with one another via the network 108. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, a Storage-as-a-Service (STaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be at least partially implemented outside of the cloud infrastructure context, as in the case of a stand-alone computing and storage system implemented within a given enterprise.

One or more of the application servers 103 may comprise, for example, application servers, database servers and/or portions of one or more server systems. Such devices are examples of what are more generally referred to herein as “processing devices.” Some of these processing devices are also generally referred to herein as “computers.” The application servers and/or database servers may be implemented using virtual and/or physical machines. The application servers in some embodiments comprise respective servers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

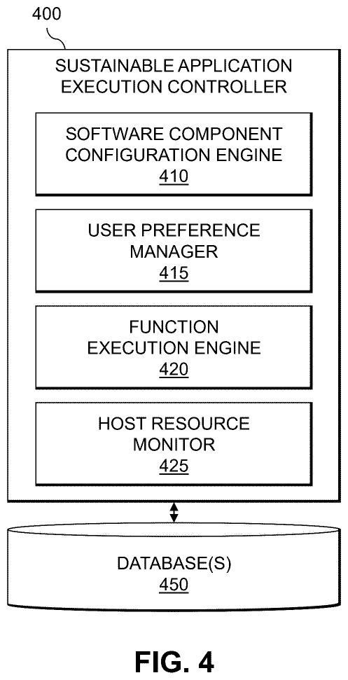

As shown in FIG. 4, one or more of the application servers 103 comprise a sustainable application execution controller 140, discussed further below in conjunction with FIG. 4. It is noted that in some embodiments, a given application server 103 comprising a sustainable application execution controller 140 may be dedicated to performing the disclosed techniques for function execution using selected execution modes or the given application server 103 may also host applications or portions thereof.

In the FIG. 1 embodiment, the orchestration engine 112 includes a deployment module 114, an image transfer module 116 and a virtualization platform integration module 118. The deployment module 114 is configured in some embodiments to deploy one or more virtual resources (not shown in FIG. 1). The image transfer module 116 may be configured to transfer templates of such virtual resources (e.g., virtual machines and/or containers) to and/or from the host devices 102, virtualization platform 122 and/or an image datastore 106, discussed below. The virtualization platform integration module 118 integrates the orchestration engine 112 with the virtualization platform 122. The orchestration engine 112 may be implemented, for example, at least in part, using the Kubernetes open-source container orchestration system for automating deployment, scaling, and management of containers in one or more clusters. The orchestration engine 112 may provide a centralized management interface for monitoring and controlling the containers in a given cluster.

Images and other templates provide building blocks for container-based orchestration. Images and other templates comprise snapshots of a file system of a container that include the dependencies and configuration information needed to run a specific application or service. When a container is created from an image, for example, the container starts with the same file system as the image, allowing for consistency and predictability in the behavior of the container. Such images can be stored in a registry, such as image datastore 106, and can be pulled and run on any machine that has a container runtime.

At least portions of the functionality of the deployment module 114, the image transfer module 116 and/or the virtualization platform integration module 118 may be implemented at least in part in the form of software that is stored in memory and executed by a processor.

The virtualization platform 122, as shown in FIG. 1, comprises an image processing agent 124, a virtualization management server 128 and one or more hypervisors 130. The exemplary image processing agent 124 processes templates, such as obtaining one or more needed container images that are not available to the virtualization platform 122 at the time of a virtual resource deployment, and processing the obtained virtual resource templates to replicate (e.g., clone) a needed virtual resource using the template and associated deployment information. In some embodiments, the exemplary image processing agent 124 may be an agent of the orchestration engine 112. The virtualization management server 128 provides one or more functions for managing at least portions of the virtualization platform 122. In addition, the exemplary virtualization platform 122 further comprises one or more hypervisors 130 to execute one or more deployed virtual resources.

Additionally, the host devices 102, the orchestration engine 112 and/or the virtualization platform 122 can have an associated image datastore 106 configured to store container images or other virtual resource templates. The image datastore 106 in the present embodiment can be implemented using storage provided by one or more of the host devices 102 and/or a storage system (not shown in FIG. 1), or the image datastore 106 can be accessed over the network 108. Such storage systems can comprise any of a variety of different types of storage including network-attached storage (NAS), storage area networks (SANs), direct-attached storage (DAS) and distributed DAS, as well as combinations of these and other storage types, including software-defined storage. While the image datastore 106 is shown in FIG. 1 as a single datastore, the image datastore 106 may be implemented using multiple datastores, as would be apparent to a person of ordinary skill in the art.

The host devices 102, the orchestration engine 112 and/or the virtualization platform 122 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines or containers, or combinations of both as in an arrangement in which containers are configured to run on virtual machines.

The host devices 102, the orchestration engine 112 (or one or more components thereof such as the deployment module 114, image transfer module 116 and/or virtualization platform integration module 118) and the virtualization platform 122 may be implemented on respective distinct processing platforms, although numerous other arrangements are possible. For example, in some embodiments at least portions of one or more of the host devices 102, the orchestration engine 112 and the virtualization platform 122 are implemented on the same processing platform. The orchestration engine 112 and/or the virtualization platform 122 can therefore be implemented at least in part within at least one processing platform that implements at least a subset of the host devices 102.

The network 108 may be implemented using multiple networks of different types to interconnect storage system components. For example, the network 108 may comprise a portion of a global computer network such as the Internet, although other types of networks can be employed, including a wide area network (WAN), a local area network (LAN), a satellite network, a telephone or cable network, a cellular network, a wireless network such as a WiFi or WiMAX network, or various portions or combinations of these and other types of networks. The network 108 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The virtualization platform 122 in some embodiments may be implemented as part of a cloud-based system.

The host devices 102, the orchestration engine 112 and/or the virtualization platform 122 can be part of what is more generally referred to herein as a processing platform comprising one or more processing devices each comprising a processor coupled to a memory. A given such processing device may correspond to one or more containers or other types of virtualization infrastructure such as virtual machines. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The virtualization platform 122 and the orchestration engine 112 may be implemented at least in part in the first geographic location, the second geographic location, and one or more other geographic locations. Thus, it is possible in some implementations of the system 100 for different ones of the host devices 102, the orchestration engine 112, and the virtualization platform 122 to reside in different data centers.

Numerous other distributed implementations of the host devices 102, the orchestration engine 112, and/or the virtualization platform 122 are possible. Accordingly, the host devices 102, the orchestration engine 112, and/or the virtualization platform 122 can also be implemented in a distributed manner across multiple data centers.

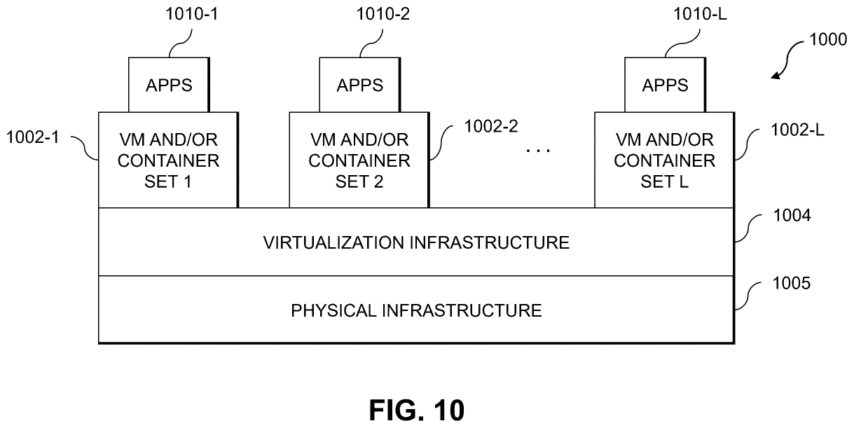

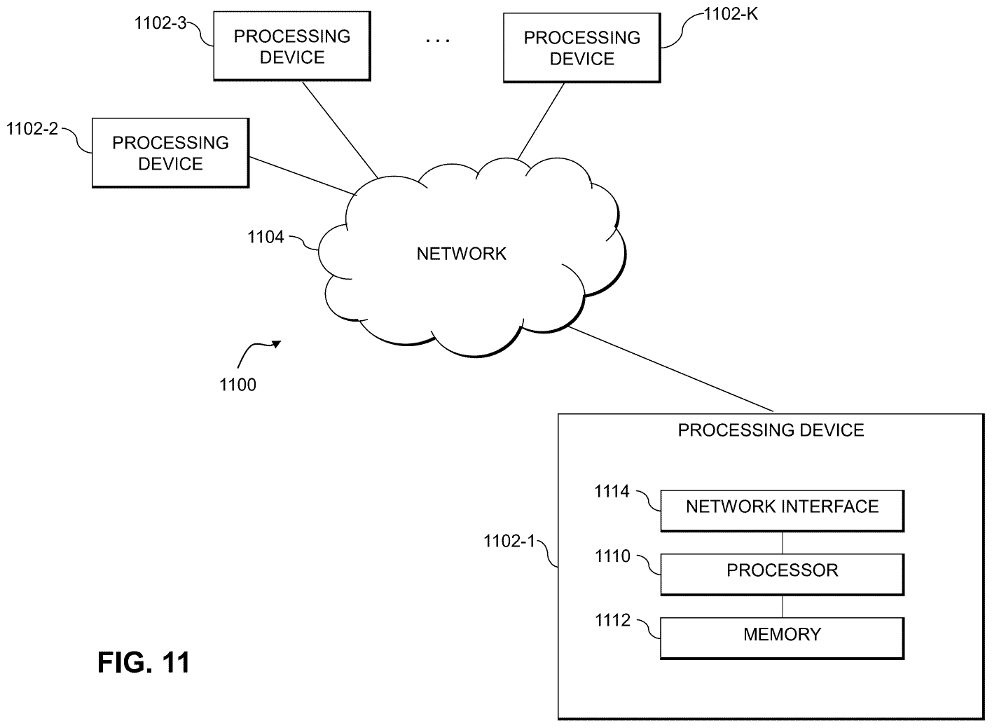

Additional examples of processing platforms utilized to implement portions of the system 100 in illustrative embodiments will be described in more detail below in conjunction with FIGS. 10 and 11.

It is to be understood that the particular set of elements shown in FIG. 1 for function execution using selected execution modes is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

For example, the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

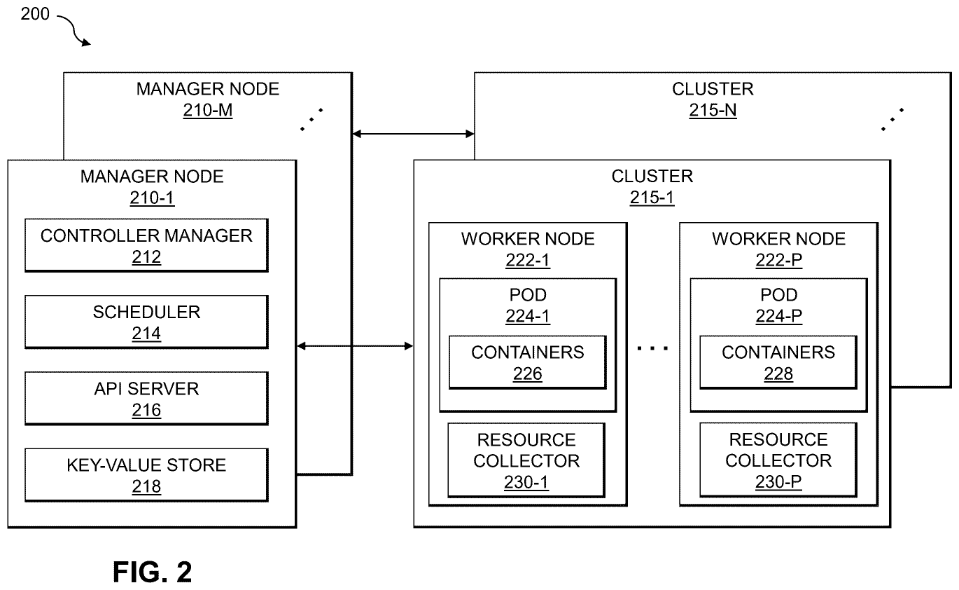

FIG. 2 depicts an example of a pod-based container orchestration environment 200 in an illustrative embodiment. In the example shown in FIG. 2, a plurality of manager nodes 210-1, . . . 210-M (herein each individually referred to as a manager node 210 or collectively as manager nodes 210) are operatively coupled to a plurality of clusters 215-1, . . . 215-N (herein each individually referred to as a cluster 215 or collectively as clusters 215). Each cluster 215 may be managed by at least one manager node 210.

As shown in FIG. 2, each manager node 210 comprises a controller manager 212, a scheduler 214, an application programming interface (API) server 216, and a key-value store 218. It is to be appreciated that in some embodiments, multiple manager nodes 210 may share one or more of the same controller manager 212, scheduler 214, API server 216, and a key-value store 218.

Each cluster 215 comprises a plurality of worker nodes 222-1, . . . 222-P (herein each individually referred to as a worker node 222 or collectively as worker nodes 222). Each worker node 222 comprises a respective pod, i.e., one of a plurality of pods 224-1, . . . 224-P (herein each individually referred to as a pod 224 or collectively as pods 224), and a respective resource collector, i.e., one of a plurality of resource collectors 230-1, . . . 230-P (herein each individually referred to as a resource collector 230 or collectively as resource collectors 230). However, it is to be understood that one or more worker nodes 222 can run multiple pods 224 at a time. Each pod 224 comprises a set of one or more containers (e.g., containers 226 and 228). It is noted that each pod 224 may also have a different number of containers. As used herein, a pod may be referred to more generally as a containerized workload. Each resource collector 230 is configured to collect information (e.g., pertaining to resource utilization) related to its corresponding worker node 222, as explained in more detail elsewhere herein.

Worker nodes 222 of each cluster 215 execute one or more applications associated with pods 224 (e.g., containerized workloads executing test scripts). In at least some embodiments, each test script is containerized and a given pod 224 executes one containerized application. Each manager node 210 manages the worker nodes 222, and therefore pods 224 and containers, in its corresponding cluster 215 based at least in part on the information collected by its resource collectors 230. More particularly, each manager node 210 controls operations in its corresponding cluster 215 utilizing the above-mentioned components, e.g., controller manager 212, scheduler 214, API server 216, and key-value store 218, based at least in part on the information collected by the resource collectors 230. In general, controller manager 212 executes control processes (e.g., controllers) that are used to manage operations, for example, in the worker nodes 222. Scheduler 214 typically schedules pods to run on particular worker nodes 222 taking into account node resources and application execution requirements such as, but not limited to, deadlines. In general, in a Kubernetes implementation, API server 216 exposes the Kubernetes API, which is the front end of the Kubernetes container orchestration system. Key-value store 218 typically provides key-value storage for all cluster data including, but not limited to, configuration data objects generated, modified, deleted, and otherwise managed, during the course of system operations.

The functionality associated with the elements 212, 214, 216, and/or 218 in other embodiments can also be combined into a single module, or separated across a larger number of modules. As another example, multiple distinct processors can be used to implement different ones of the elements 212, 214, 216, and/or 218 or portions thereof.

At least portions of elements 212, 214, 216, and/or 218 may be implemented at least in part in the form of software that is stored in memory and executed by a processor.

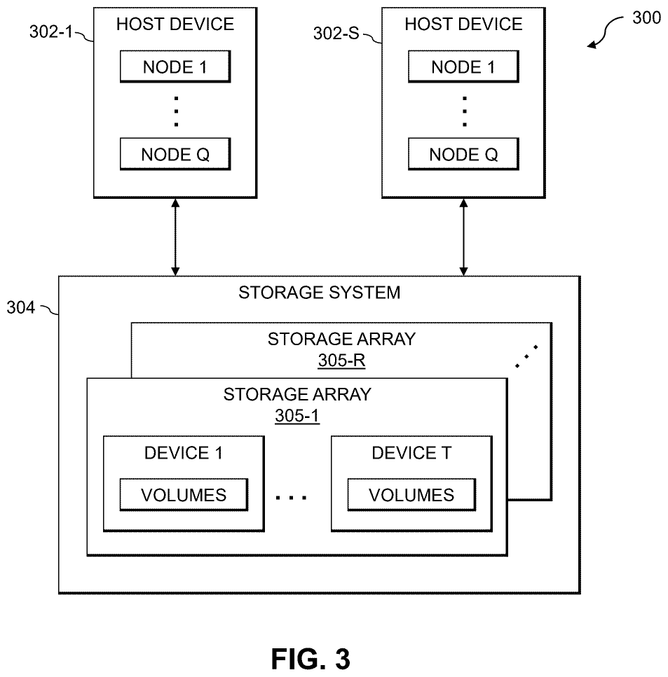

Turning now to FIG. 3, an information processing system 300 is depicted within which the pod-based container orchestration environment 200 of FIG. 2 can be implemented. More particularly, as shown in FIG. 3, a plurality of host devices 302-1, . . . 302-S (herein each individually referred to as a host device 302 or collectively as host devices 302) are operatively coupled to a storage system 304. Each host device 302 hosts a set of nodes 1, . . . . Q. Note that while multiple nodes are illustrated on each host device 302, a host device 302 can host a single node, and one or more host devices 302 can host a different number of nodes as compared with one or more other host devices 302.

As further shown in FIG. 3, storage system 304 comprises a plurality of storage arrays 305-1, . . . 305-R (herein each individually referred to as a storage array 305 or collectively as storage arrays 305), each of which is comprised of a set of storage devices 1, . . . . T upon which one or more storage volumes are persisted. The storage volumes depicted in the storage devices of each storage array 305 can include any data generated in the information processing system 300 but, more typically, include data generated, manipulated, or otherwise accessed, during the execution of one or more applications in the nodes of host devices 302. One or more storage arrays 305 may comprise a different number of storage devices as compared with one or more other storage arrays 305.

Furthermore, any one of nodes 1, . . . . Q on a given host device 302 can be a manager node 210 or a worker node 222 (FIG. 2). In some embodiments, a node can be configured as a manager node for one execution environment and as a worker node for another execution environment. Thus, the components of pod-based container orchestration environment 200 in FIG. 2 can be implemented on one or more of host devices 302, such that data associated with pods 224 (FIG. 2) running on the nodes 1, . . . . Q is stored as persistent storage volumes in one or more of the storage devices 1, . . . . T of one or more of storage arrays 305.

Host devices 302, storage system 304 and the pod-based container environment are assumed to be implemented using at least one processing platform comprising one or more processing devices each having a processor coupled to a memory. Such processing devices can illustratively include particular arrangements of compute, storage, and network resources. In some alternative embodiments, one or more host devices 302, storage system 304 and/or the pod-based container environment can be implemented on respective distinct processing platforms and/or on the same processing platform.

In at least some embodiments, distributed implementations of information processing system 300 are possible, in which certain components of the system reside in one data center in a first geographic location while other components of the system reside in one or more other data centers in one or more other geographic locations that are potentially remote from the first geographic location. Thus, it is possible in some implementations of information processing system 300 for portions or components thereof to reside in different data centers. Numerous other distributed implementations of information processing system 300 are possible. Accordingly, the constituent parts of information processing system 300 can also be implemented in a distributed manner across multiple computing platforms.

Additional examples of processing platforms utilized to implement containers, container environments, and container management systems in illustrative embodiments, such as those depicted in FIGS. 2 and 3, will be described in more detail below in conjunction with additional figures.

It is to be appreciated that these and other features of illustrative embodiments are presented by way of example only, and should not be construed as limiting in any way.

Accordingly, different numbers, types and arrangements of system components can be used in other embodiments. Although FIG. 3 shows an arrangement wherein host devices 302 are coupled to just one plurality of storage arrays 305, in other embodiments, host devices 302 may be coupled to and configured for operation with storage arrays across multiple storage systems similar to storage system 304.

It should be understood that the particular sets of components implemented in information processing system 300 as illustrated in FIG. 3 are presented by way of example only. In other embodiments, only subsets of these components, or additional or alternative sets of components, may be used, and such components may exhibit alternative functionality and configurations. Additional examples of systems implementing pod-based container management functionality will be described below.

Still further, information processing system 300 may be part of a public cloud infrastructure. The cloud infrastructure may also include one or more private clouds and/or one or more hybrid clouds (e.g., a hybrid cloud is a combination of one or more private clouds and one or more public clouds).

A Kubernetes pod may be referred to more generally herein as a containerized workload. One example of a containerized workload is an application program configured to execute one or more microservices of an application.

Container-based microservice architectures have changed the way development and operations teams deploy modern software. Containers help companies modernize by making it easier to scale and deploy applications. The pod brings the containers together and makes it easier to scale and deploy applications. Kubernetes clusters allow containers to run across multiple machines and environments: such as virtual, physical, cloud-based, and on-premises environments. As shown and described above in the context of FIG. 2, Kubernetes clusters are generally comprised of one manager (master) node and one or more worker nodes. These nodes can be physical computers and/or virtual machines (VMs), depending on the cluster. Typically, a given cluster is allocated a fixed number of resources (e.g., CPU (central processing unit), memory, and/or other computer resources), and when a container is defined the number of resources from among the resources allocated to the cluster is specified. When the container starts executing, one or more pods are created on the deployed container that will serve the incoming requests.

As noted above, however, one or more aspects of the disclosure recognize that every use case does not require a high priority execution and that performance improvements, such as horizontal scaling, may impair sustainability in multiple ways.

FIG. 4 illustrates an example of the sustainable application execution controller of FIG. 1 in an illustrative embodiment. In the example of FIG. 4, the sustainable application execution controller 400 comprises a software component configuration engine 410, a user preference manager 415, a function execution engine 420 and a host resource monitor 425.

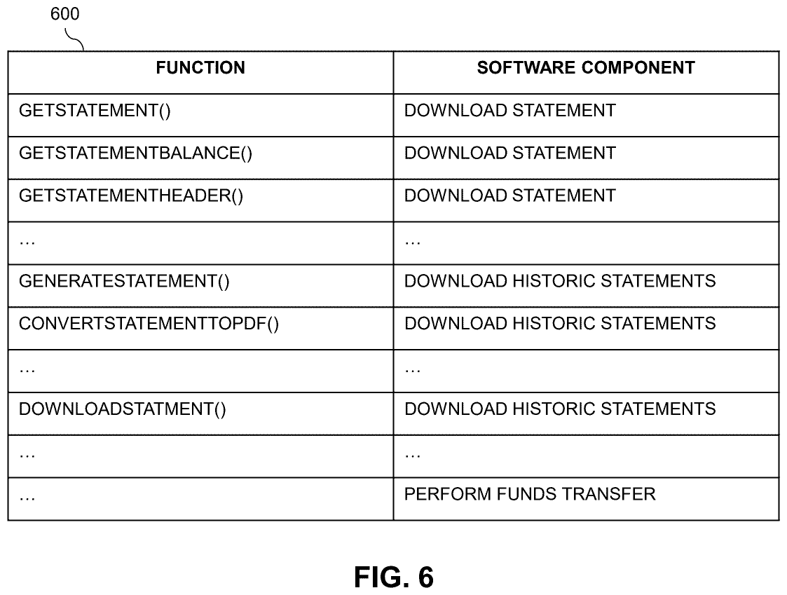

In some embodiments, the software component configuration engine 410 interacts with application developers that provide a configuration of various function names that will be executed using the sustainable application execution controller 400 and which software components the various functions map to, as discussed further below in conjunction with FIG. 6, for example. In at least some embodiments, the software component configuration engine 410 provides a user interface to interact with application developers and/or a JSON (JavaScript Object Notation)-based configuration file, for example, where developers can directly embed the mapping of function names to software components. Developers can mention function names, nominate function classes, and/or one or more NuGet package managers, dynamic link libraries (DLLs) or other reusable components to map to specific software components. Developers also use the software component configuration engine 410 to store a default configuration (e.g., what happens when the function being executed does not exist in the configuration and no directive has been provided). In this case, the developers can use a default configuration that decides if the code will be executed with a performance-based execution (e.g., a multi-threaded execution) or a more sustainable execution.

The user preference manager 415 may provide a listing to users, for example, using a micro frontend, of the available software components and available execution modes (e.g., performance profiles). The listing may be provided to end users, for example, in a user preference or user profile section of a website or directly in the application. Users can access the list of software components and select a corresponding performance profile for each software component, for example, using preconfigured performance profiles (e.g., a performance mode, a sustainability mode and/or an automatic mode).

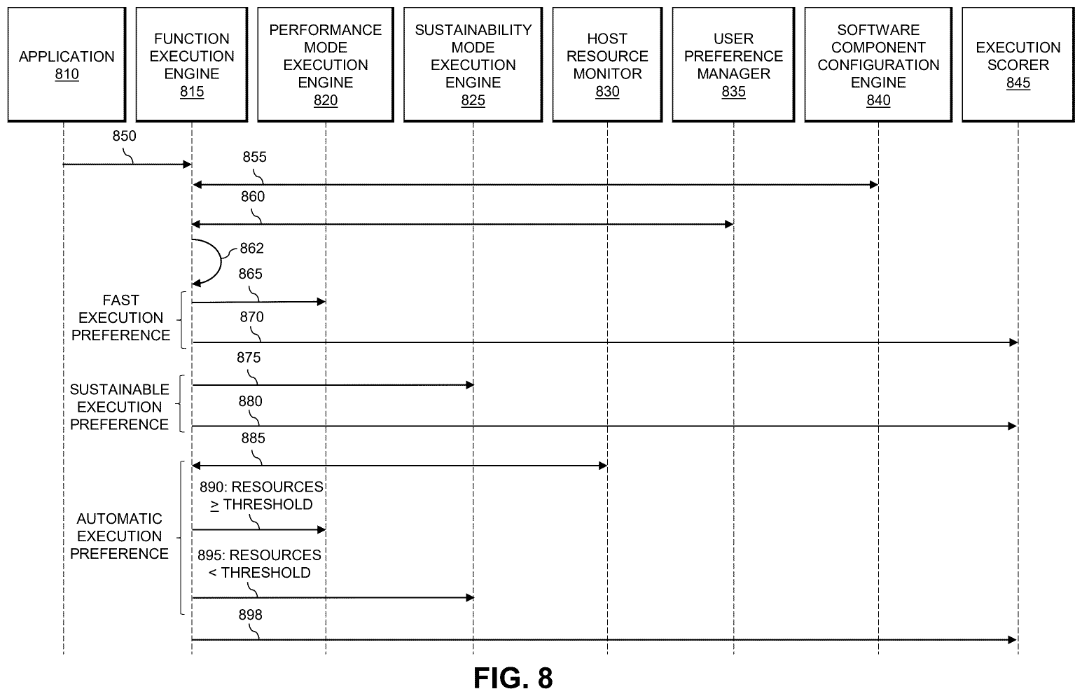

In one or more embodiments, the function execution engine 420 executes functions using the amount of compute resources associated with the selected execution mode (or performance profile) of a given user for the software components comprising such functions, as discussed further below in conjunction with FIG. 8, for example. The functions may be provided to the function execution engine 420, for example, with the following parameters:
a. a pointer to a function, delegate or ClassName followed by a function name or a fully qualified function name inside a DLL. This function pointer, delegate or specific function of a class is executed when an “ExecuteFunction” method of the function execution engine 420 is invoked;
b. a user identifier (ID), such as a profile, a username or another ID of the user who is currently requesting the execution of a function (the calling code of a website, for example, typically has the username in a security token-based cookie or in the user context and therefore this can be passed to the function execution engine 420); and
c. a return type, which is typically the same return type as that of the function that is invoked through the function pointer or delegate or directly using reflection (e.g., the return type parameter allows strongly typed return values to be consumed by the calling code).

Given that the function execution engine 420 has the code to execute in the form of a function pointer, class/function name or a fully qualified execution path inside a NuGet, DLL or reusable component; the software component to which the function or code belongs and the user who is executing the code, the function execution engine 420 can dynamically mediate:
a. how the function should be invoked;
b. how many threads should be spawned to invoke the function;
c. what should be the priority of the one or more threads being invoked;
d. how many resources should be allocated for the execution of the code (e.g., a fastest execution or a more sustainable execution); and
e. in the case of an automatic performance mode, the function execution engine 420 also applies a configurable heuristic or a simple threshold, as discussed further below.

The host resource monitor 425, in at least some embodiments, monitors the usage of resources, such as compute resources. In an automatic performance mode, the resource utilization can be evaluated and a requested function will be executed in a performance mode (e.g., by utilizing a higher amount of compute resources) if the resource utilization of the host node is below a designated threshold (or satisfies one or more resource utilization criteria) and will be executed in a sustainable mode (e.g., by utilizing a reduced amount of compute resources, relative to the performance mode) if the resource utilization of the host node is above the designated threshold (or satisfies one or more resource utilization criteria).

The functionality associated with the elements 410, 415, 420 and/or 425 in other embodiments can also be combined into a single module, or separated across a larger number of modules. As another example, multiple distinct processors can be used to implement different ones of the elements 410, 415, 420 and/or 425 or portions thereof.

At least portions of elements 410, 415, 420 and/or 425 may be implemented at least in part in the form of software that is stored in memory and executed by a processor.

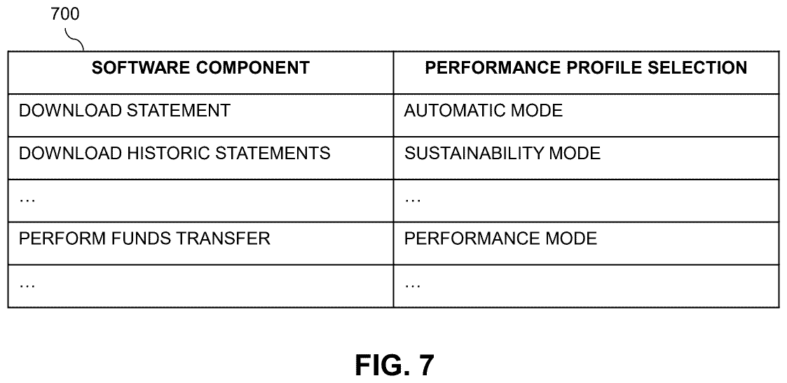

The sustainable application execution controller 400 communicates (e.g., over a network not shown in FIG. 4) with a database 450. The sustainable application execution controller 400 utilizes various information stored in the database 450, such as the tables of FIGS. 6 and 7, discussed further below.

In some embodiments, the sustainable application execution controller 400 is used for an enterprise system. For example, an enterprise may subscribe to or otherwise utilize the function execution using selected execution modes provided by the sustainable application execution controller 400 to reduce carbon emissions of the enterprise. As used herein, the term “enterprise system” is intended to be construed broadly to encompass any group of systems or other computing devices. For example, the various clusters 215 of the pod-based container orchestration environment 200 may provide a portion of one or more enterprise systems. A given enterprise system may also or alternatively include one or more of the host devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

One or more aspects of the disclosure recognize that an application can be launched (e.g., by Kubernetes) by setting the number of pods for the application. Each pod has a containerized environment that has the resources to execute the exact same application. In addition, load balancing techniques may be employed whereby the pods can be deployed to different worker nodes 222, to let the worker nodes 222 share the load from the running applications.

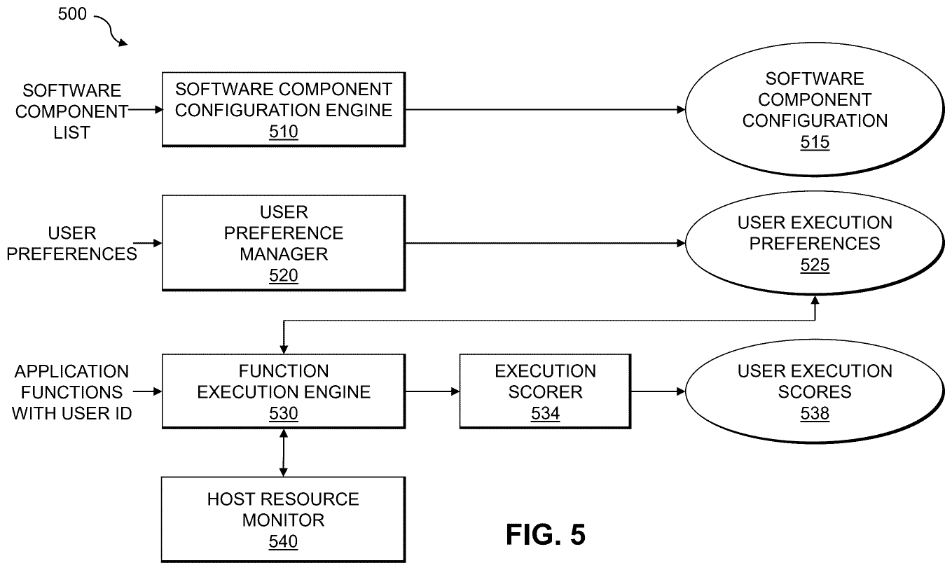

FIG. 5 illustrates an operation 500 of the software component configuration engine, user preference manager, function execution engine and host resource monitor of FIG. 4 in an illustrative embodiment. In the example of FIG. 5, the software component configuration engine 510 interacts with application developers that provide a software component list comprising a configuration of various functions of an application that will be executed using the sustainable application execution controller 400. The generated software component configuration 515 maps each function to a corresponding software component, as discussed further below in conjunction with FIG. 6, for example. As noted above, the software component configuration engine 510 may provide a user interface to interact with the application developers and/or a JSON-based configuration file, for example, where developers can directly embed the mapping of function names to software components. Developers also use the software component configuration engine 510 to store a default software component configuration 515 (e.g., what happens when the function being executed does not exist in the configuration and no directive has been provided). In this case, the developers can use a default software component configuration 515 that decides if the code will be executed in a performance mode (e.g., a multi-threaded execution) or a sustainable mode, for example.

In some embodiments, the user preference manager 520 provides a listing to users, for example, using a micro frontend, of the available software components and available execution modes (e.g., performance profiles) for the user to generate user execution preferences 525 that assign a selected performance profile to each software component, as discussed further below in conjunction with FIG. 7, for example. The listing may be provided to end users, for example, in a user preference or user profile section of a website or directly in the application. As noted above, users can access the list of software components and select a corresponding performance profile for each software component, for example, using preconfigured performance profiles (e.g., a performance mode, a sustainability mode and/or an automatic mode).

As shown in FIG. 5, application functions, along with a corresponding user ID, are applied to the function execution engine 530. The function execution engine 530 will use the user ID and the software component configuration 515 to access the user execution preferences 525 for the user that assigns a selected performance profile to the software component that comprises the function to be executed. The function execution engine 530 uses the selected performance profile of the user to execute the function using the amount of compute resources associated with the selected execution mode (or performance profile) for the software components comprising the function, as discussed further below in conjunction with FIG. 8, for example.

In one or more embodiments, the host resource monitor 540 monitors the usage of resources, such as compute resources. In an automatic performance mode, the resource utilization can be evaluated and a requested function will be executed by the function execution engine 530 in a performance mode (e.g., by utilizing a higher amount of compute resources) if the resource utilization of the host node, as reported by the host resource monitor 540, is below a designated threshold (or satisfies one or more resource utilization criteria) and will be executed in a sustainable mode (e.g., by utilizing a reduced amount of compute resources, relative to the performance mode) if the resource utilization of the host node is above the designated threshold (or satisfies one or more resource utilization criteria). The host resource monitor 540 may periodically analyze the CPU usage, the RAM utilization and/or other resource utilization on the container or the host where the application is executing to determine which execution mode should be used for each function.

In some embodiment, an execution scorer 534 may be employed to assign user execution scores 538 to the execution of functions for each user. Given that the user profile under which each function executed is available to the system, the execution scorer 534 can create a point-based user execution score 538 of the function execution. For example, an aggregate user execution score 538 can be assigned to each user profile, where, for example, a higher score may indicate a more sustainable user profile (and vice versa). If the user did not select a performance mode for a given function that is executed, an execution score of 0 may be assigned to the execution. An exemplary sustainability score may be expressed, as follows:

$$S = \frac{\sum ( group\_by \_funtion ( profile score of f ( ) * count ( f ( ) )}{\sum Executions or Requests for User} ,$$

where f( ) indicates an execution of a specific function or each request to invoke a function. The sustainability score may be part of a gamification process in some embodiments, that allows an organization to tie different sustainability scores to each user profile. The scoring formula may be different from one organization to another. In addition, each organization may specify the scoring formula and the types of gamification aspect and rewards or incentives (financial, recognition or otherwise), if any, that are provided. The sustainability score may be displayed in a user profile along with a tally of the number of executions under the user profile. A color shade may be employed that shows how “green” the user is. Micro frontends may be embedded in the user profile that illustrate the choices other users within a team and/or an organization are making for comparison to the sustainability choices of a particular user. In addition, the most environmentally responsible users in an organization (e.g., the top N most sustainable users) may be identified and incentives and/or rewards can be provided within the organization.

FIG. 6 is a sample table 600 illustrating an exemplary software component configuration 515 of FIG. 5 that maps software functions to software components in an illustrative embodiment. As noted above, the mapping shown in FIG. 6 may be specified, for example, by one or more developers of a given application. In the example of FIG. 6, a banking application is considered, where a download statement software component, a download historic statement software component and a perform funds transfer software component are shown.

As shown in FIG. 6, a get statement function, a get statement balance function and a generate statement header function are all mapped by the developer to the download statement software component. In addition, a generate statement function, a convert statement to PDF function, and a download statement function all map to the download historic statements software component. In addition, additional functions (not shown in FIG. 6) may be mapped to the perform funds transfer software component. Generally, for the functions appearing in a given application, one or more developers designate the software component to which the respective functions belong.

In the banking application considered in FIG. 6, a first user may want a fast performance for everything and may not care about sustainability. A second user may not mind a slower performance for everything in order to lower the carbon footprint. A third user, however, may care about the environment while also being focused on productivity. Thus, the third user may select the fastest possible performance when transferring funds but may select a sustainable preference (e.g., a power saving mode) when downloading historic bank statements. Similarly, in an electronic commerce application, the third user may select a fast performance while browsing a catalog but may accept a slower performance when completing a checkout in a shopping cart portion of the application or when browsing historic orders. Finally, the third user may select an automatic performance mode when executing reports that span six months or more. In this manner, when the third user is viewing such reports in an absence of high traffic on the host, the third user experiences a fastest possible output, but when there is a load on the host, the third user experiences a slower report generation (but avoids the spawning of additional hosts to provide a faster experience).

FIG. 7 is a sample table 700 illustrating exemplary user execution preferences 525 of FIG. 5 indicating user performance profile selections of a given user for a number of exemplary software components in an illustrative embodiment. In the example of FIG. 7, the user has designated an automatic mode for the download statement software component, a sustainability mode for the download historic statements software component and a performance mode for the perform funds transfer software component.

FIG. 8 is a communication diagram illustrating the techniques for function execution using selected execution modes in an illustrative embodiment. In the example of FIG. 8, an application 810 provides one or more functions 850, along with the user ID, to a function execution engine 815. The function execution engine 815 interacts with a software component configuration engine 840 (e.g., software component configuration engine 510) to obtain a software component configuration 855 (e.g., software component configuration 515) specified by one or more developers of the application comprising the functions to be executed.

In addition, the function execution engine 815 interacts with a user preference manager 835 (e.g., user preference manager 520) to obtain user execution preferences 860 (e.g., user execution preferences 525). As noted above, the user execution preferences 860 comprise a user selection of an execution mode (e.g., a performance profile) for the available software components of the application.

The function execution engine 815 performs an evaluation 862 of the obtained software component configuration 855 and the user execution preferences 860 to identify the execution mode specified by the user for the software component that comprises the function to be executed. If, for example, a fast execution preference was indicated (e.g., associated with a performance mode), the function execution engine 815 provides the function to a performance mode execution engine 820 in step 865 and then provides metrics associated with the execution to an execution scorer 845 in step 870 for calculation of a sustainability score. The performance mode execution engine 820 will allocate an amount compute resources to an execution of the function consistent with the designated performance mode.

If, for example, a sustainable execution preference was indicated (e.g., associated with a sustainable mode), the function execution engine 815 provides the function to a sustainability mode execution engine 825 in step 875 and then provides one or more metrics associated with the execution to the execution scorer 845 in step 880 for calculation of a sustainability score. The sustainability mode execution engine 825 will allocate an amount compute resources to an execution of the function consistent with the designated sustainability mode.

If, for example, an automatic execution preference was indicated (e.g., associated with an automatic mode), the function execution engine 815 will interact with the host resource monitor 830 (e.g., host resource monitor 540) in step 885 to determine the amount of compute resources that are currently available. In an alternate implementation, the host resource monitor 830 may report the amount of compute resources that are currently being consumed, as would be apparent to a person of ordinary skill in the art. The function execution engine 815 compares the amount of available resources, for example, to a designated resource threshold, such as a 60% CPU and/or a 60% RAM threshold (or uses one or more resource evaluation criteria). Thus, if the hosts are running below capacity (e.g., below the designated threshold) the function can be executed with full resources but if the hosts are above the designated threshold the user has indicated that a slower experience is acceptable to improve sustainability.

If it is determined in step 890 that the amount of available resources is greater than, or equal to, the designated resource threshold, then the function execution engine 815 provides the function to the performance mode execution engine 820, which executes the function in the manner described above. If it is determined in step 895 that the amount of available resources is less than the designated resource threshold, then the function execution engine 815 provides the function to the sustainability mode execution engine 825, which executes the function in the manner described above. The function execution engine 815 provides one or more metrics associated with the function execution to the execution scorer 845 in step 898 for calculation of a sustainability score.

As noted above, in an automatic mode, the function execution engine 815 determines whether a function having an automatic performance profile should be executed in sustainability mode or a performance mode (e.g., having a faster execution). The function execution engine 815 interacts with the host resource monitor 830 to periodically analyze the compute resource usage (e.g., CPU usage, RAM utilization and/or other resource utilization) on the host and decides which execution mode should be used.

When a lower number of users exist on the host, the system can allow the requests on the host to consume more CPU cycles (and other compute resources) and execute with the fastest performance possible, for example. As more execution traffic exists in the system, the function execution engine 815 prevents horizontal scaling, for example, for users who have selected an automatic performance and slows the performance down which may reduce the carbon footprint, awards sustainability points or other rewards in the spirit of gamification and avoids spawning new nodes or hosts, which increases power and costs and negatively impacts sustainability.

It is noted that offering the option of selecting between a sustainable execution mode and an automatic execution mode provides better sustainability compared to only offering a performance mode (e.g., with a fastest execution mindset). Some users may want to select the performance mode, but other users are provided with an option to select the sustainable execution mode and/or the automatic execution mode for software components that are not critical and where the users do not mind waiting a little longer for the function execution to complete.

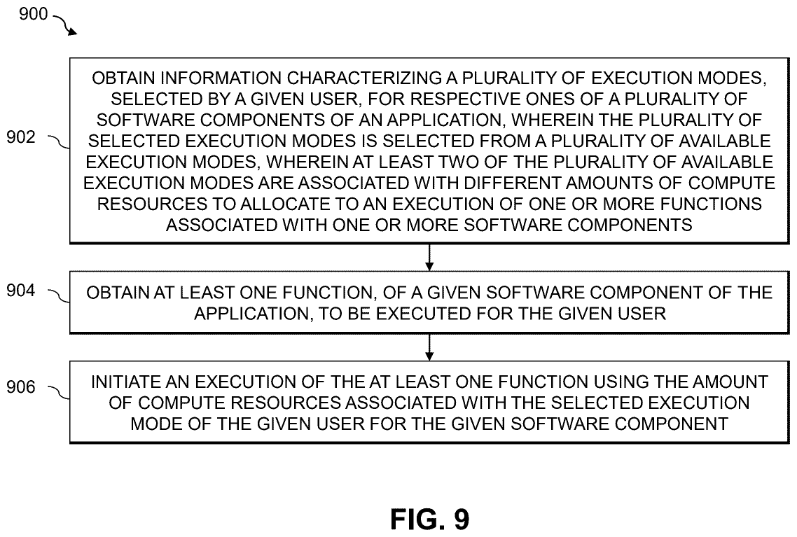

FIG. 9 is a flow diagram illustrating an exemplary implementation of a process 900 for function execution using selected execution modes in an illustrative embodiment. In the example of FIG. 9, the process 900 includes steps 902 through 906. These steps are assumed to be performed, for example, by the sustainable application execution controller 400 of FIG. 4. The process begins at step 902, where information is obtained characterizing a plurality of execution modes, selected by a given user, for respective ones of a plurality of software components of an application, wherein the plurality of selected execution modes is selected from a plurality of available execution modes, wherein at least two of the plurality of available execution modes are associated with different amounts of compute resources to allocate to an execution of one or more functions associated with one or more software components.

In step 904, at least one function, of a given software component of the application, to be executed for the given user is obtained. As used herein, the term “function” shall be broadly construed to encompass any portion of software code of an application, such as a software code task, including functions inside objects, functions in classes of a package and functions invoked using a function pointer, a function delegate or a function event, as would be apparent to a person of ordinary skill in the art.

An execution of the at least one function is initiated in step 906 using the amount of compute resources associated with the selected execution mode of the given user for the given software component. As used herein, the phrase “different amount of compute resources” associated with the at least two execution modes shall be broadly construed to encompass a first amount of compute resources associated with a first execution mode relative to a different amount of compute resources associated with a second execution mode; a first amount of available compute resources (or a percentage or portion of the available amount of compute resources) associated with a first execution mode relative to a different amount of available compute resources (or a percentage or portion of the available amount of compute resources) associated with a second execution mode; a first amount of compute resources associated with a first number of execution threads of a first execution mode relative to a different amount of compute resources associated with a different number of execution threads of a second execution mode; a first amount of compute resources associated with a first degree of horizontal scaling of such compute resources in a first execution mode relative to a different amount of compute resources associated with a second degree of horizontal scaling of such compute resources in a second execution mode; a first amount of compute resources associated with a first number of processing cores of a first execution mode relative to a different amount of compute resources associated with a second number of processing cores of a second execution mode; a first amount of compute resources needed to satisfy a first processing time threshold of a first execution mode relative to a different amount of compute resources needed to satisfy a second processing time threshold of a second execution mode and/or a first amount of compute resources needed to achieve a baseline performance level of a first execution mode relative to a different amount of compute resources needed to achieve a reduced performance level of a second execution mode.

In some embodiments, a first available execution mode comprises a first amount of compute resources to allocate to the execution of the one or more functions associated with the given software component and a second available execution mode comprises a second amount of compute resources to allocate to the execution of the one or more functions associated with the one or more software components, wherein the first amount of compute resources is greater than the second amount of compute resources.

In one or more embodiments, a third available execution mode may comprise an automatic mode and wherein the amount of the compute resources to allocate to the execution of the one or more functions associated with the one or more software components is based at least in part on a determination of whether an amount of compute resources being utilized satisfies one or more designated criteria. The at least one function may be executed in a performance mode in response to the amount of the available compute resources exceeding at least one designated compute resource threshold. The at least one function may be executed in a sustainability mode in response to the amount of the available compute resources not exceeding at least one designated compute resource threshold.

In at least one embodiment, the obtaining the at least one function may comprise obtaining an identifier of the given user associated with the at least one function. A score may be assigned to the execution of the at least one function based at least in part on the amount of compute resources associated with the execution.

The particular processing operations and other system functionality described in conjunction with FIGS. 5, 8 and 9 are presented by way of illustrative example only, and should not be construed as limiting the scope of the disclosure in any way. Alternative embodiments can use other types of processing operations for function execution using selected execution modes. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Consider a microservice for downloading historic invoices with an assumption that a fastest response is always desirable. Thus, as the invoices are generated, converted to PDF files and then streamed as response streams to the browsers of end users, a load on the servers is heavy. Automatic scaling is typically activated and rarely automatically scales down, such that the servers are running at a full capacity (e.g., 16 containers). When users are given the option, it has been found that approximately half of the users do not feel that an instant response is needed when downloading invoices and do not mind waiting for a bit longer for the invoices. These users may select a sustainable execution setting using the disclosed techniques for this specific software component and the number of microservice containers may be reduced from 16 containers to 12 containers, for example, having a considerable positive impact. Users who select the slower execution may be rewarded with points, for example, and be recognized, incentivized and/or rewarded for selecting this setting.

Consider a user that often views historic orders to create invoices for customers. The user may often perform this task during late evenings when traffic on the system is lower. The user may log in and select an “automatic execution” profile for the “view historic orders” software component. Since the user usually works in the late evening, when the servers are often underutilized, for significant portions of the workflow, the user may not notice any performance difference. By choosing the automatic execution mode setting, the user has ensured that if the function is executed when the server is already being highly utilized, the function execution might be slowed down a bit rather than resulting in a spawning of additional hosts (e.g., containers). For significant portions of his or her routine, the user sees similar performance for that specific workflow and occasionally (e.g., when the server is overloaded) the user has a slightly slower experience which may be acceptable. The user may be awarded sustainability points for spending some time to identify specific software components where the user can tolerate a slower performance and for selecting an automatic performance profile only for such software components. Depending on the organization, the sustainability points can be used for rewarding, incentivizing, gamification and/or recognizing the greenest users in the enterprise.

Consider a human resources group of an organization that may be particularly aware of sustainability. For months, the human resources group may have been executing a pay-slip generation script on the last day of the month. Using the disclosed techniques, the human resources group may login to a website and see an option to execute the pay-slip generation using a “fastest execution,” a “most sustainable execution” or an “automatic/balanced execution.” The users may select a sustainable execution and realize that the script executes in three hours instead of 1.5 hours. The users adjust their routines and start the execution of the script 1.5 hours ahead of time and reduce the associated carbon emissions. A third-party vendor and/or auditors may also execute the same script and not be too concerned with sustainability (e.g., they are more interested in productivity and hence they select a “fastest execution”). By providing the execution mode options disclosed herein, the human resources group is able to just reduce their cloud processing bills (e.g., more scaling means higher costs) and also provide a more sustainable result.

Consider a user that often uses a power saving mode on his or her mobile device. The user may be aware that a power saving mode on a mobile device slows down performance but makes the battery more efficient. When the user sees a similar option to control the execution profile for functions of software components of an application, optionally along with a point system that can monetize rewards, the user may select the software components where performance is critical and the software components where a slower performance may be acceptable. The user may earn sustainability points that can be monetized and optionally illustrated in a chart showing how much carbon emission has been reduced, for example.

A given organization may be trying to encourage users to utilize reduce server resource utilization since they are running at or near cloud capacity. The organization may employ the disclosed techniques for function execution using selected execution modes to obtain a green score for each user and announce that the user with the highest green score will receive a monetary award and special recognition. Over a period of time, the users of the organization may specify a performance mode or a sustainability mode for certain software components, resulting in sizable reduction of the overall infrastructure capacity being utilized. The organization saves a sizable amount of money in monthly cloud expenses and passes a fraction of that cost to award a winner of the contest.

The organization may profile applications and identify software components where the users may not mind if the performance is slower. The organization may specify a default setting for only those software components of “sustainable performance” and realize that a significant percentage (e.g., 80%) of the users do not mind the slower performance. When the remaining users (e.g., the other 20% of users) realize that the performance is slow, they may override the default settings and select a “fastest performance” mode, for example. The organization still experiences lower bills for cloud computing and makes a contribution towards sustainability.

Advantageously, the techniques for function execution using selected execution modes described herein improve the carbon footprint of organizations and empower users to select execution modes based on a tradeoff between performance and sustainability, thereby providing a significant impact on the overall environment.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for function execution using selected execution modes will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple VMs and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for function execution using selected execution modes as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, container environments, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining information characterizing a plurality of execution modes, selected by a given user, for respective ones of a plurality of software components of an application, wherein the plurality of selected execution modes is selected from a plurality of available execution modes, wherein at least two of the plurality of available execution modes are associated with different amounts of compute resources to allocate to an execution of one or more functions associated with one or more software components;
obtaining at least one function, of a given software component of the application, to be executed for the given user; and
initiating an execution of the at least one function using the amount of compute resources associated with the selected execution mode of the given user for the given software component;
wherein the method is performed by at least one processing device comprising a processor coupled to a memory.

2. The method of claim 1, wherein a first available execution mode comprises a first amount of compute resources to allocate to the execution of the one or more functions associated with the given software component.

3. The method of claim 2, wherein a second available execution mode comprises a second amount of compute resources to allocate to the execution of the one or more functions associated with the one or more software components, wherein the first amount of compute resources is greater than the second amount of compute resources.

4. The method of claim 2, wherein a third available execution mode comprises an automatic mode and wherein the amount of the compute resources to allocate to the execution of the one or more functions associated with the one or more software components is based at least in part on a determination of whether an amount of available compute resources satisfies one or more designated criteria.

5. The method of claim 4, wherein the at least one function is executed in a performance mode in response to the amount of the available compute resources exceeding at least one designated compute resource threshold.

6. The method of claim 4, wherein the at least one function is executed in a sustainability mode in response to the amount of the available compute resources not exceeding at least one designated compute resource threshold.

7. The method of claim 1, wherein the obtaining the at least one function comprises obtaining an identifier of the given user associated with the at least one function.

8. The method of claim 1, further comprising assigning a score to the execution of the at least one function based at least in part on the amount of compute resources associated with the execution.

9. An apparatus comprising:
at least one processing device comprising a processor coupled to a memory;
the at least one processing device being configured to implement the following steps:
obtaining information characterizing a plurality of execution modes, selected by a given user, for respective ones of a plurality of software components of an application, wherein the plurality of selected execution modes is selected from a plurality of available execution modes, wherein at least two of the plurality of available execution modes are associated with different amounts of compute resources to allocate to an execution of one or more functions associated with one or more software components;
obtaining at least one function, of a given software component of the application, to be executed for the given user; and
initiating an execution of the at least one function using the amount of compute resources associated with the selected execution mode of the given user for the given software component.

10. The apparatus of claim 9, wherein a first available execution mode comprises a first amount of compute resources to allocate to the execution of the one or more functions associated with the given software component, and wherein a second available execution mode comprises a second amount of compute resources to allocate to the execution of the one or more functions associated with the one or more software components, wherein the first amount of compute resources is greater than the second amount of compute resources.

11. The apparatus of claim 10, wherein a third available execution mode comprises an automatic mode and wherein the amount of the compute resources to allocate to the execution of the one or more functions associated with the one or more software components is based at least in part on a determination of whether an amount of available compute resources satisfies one or more designated criteria.

12. The apparatus of claim 11, wherein the at least one function is executed one or more of (i) in a performance mode in response to the amount of the available compute resources exceeding at least one designated compute resource threshold, and (ii) in a sustainability mode in response to the amount of the available compute resources not exceeding at least one designated compute resource threshold.

13. The apparatus of claim 9, wherein the obtaining the at least one function comprises obtaining an identifier of the given user associated with the at least one function.

14. The apparatus of claim 9, further comprising assigning a score to the execution of the at least one function based at least in part on the amount of compute resources associated with the execution.

15. A non-transitory processor-readable storage medium having stored therein program code of one or more software programs, wherein the program code when executed by at least one processing device causes the at least one processing device to perform the following steps:
obtaining information characterizing a plurality of execution modes, selected by a given user, for respective ones of a plurality of software components of an application, wherein the plurality of selected execution modes is selected from a plurality of available execution modes, wherein at least two of the plurality of available execution modes are associated with different amounts of compute resources to allocate to an execution of one or more functions associated with one or more software components;
obtaining at least one function, of a given software component of the application, to be executed for the given user; and
initiating an execution of the at least one function using the amount of compute resources associated with the selected execution mode of the given user for the given software component.

16. The non-transitory processor-readable storage medium of claim 15, wherein a first available execution mode comprises a first amount of compute resources to allocate to the execution of the one or more functions associated with the given software component, and wherein a second available execution mode comprises a second amount of compute resources to allocate to the execution of the one or more functions associated with the one or more software components, wherein the first amount of compute resources is greater than the second amount of compute resources.

17. The non-transitory processor-readable storage medium of claim 16, wherein a third available execution mode comprises an automatic mode and wherein the amount of the compute resources to allocate to the execution of the one or more functions associated with the one or more software components is based at least in part on a determination of whether an amount of available compute resources satisfies one or more designated criteria.

18. The non-transitory processor-readable storage medium of claim 17, wherein the at least one function is executed one or more of (i) in a performance mode in response to the amount of the available compute resources exceeding at least one designated compute resource threshold, and (ii) in a sustainability mode in response to the amount of the available compute resources not exceeding at least one designated compute resource threshold.

19. The non-transitory processor-readable storage medium of claim 15, wherein the obtaining the at least one function comprises obtaining an identifier of the given user associated with the at least one function.

20. The non-transitory processor-readable storage medium of claim 15, further comprising assigning a score to the execution of the at least one function based at least in part on the amount of compute resources associated with the execution.
